(19) United States
(12) Patent Application Publication
(10) Pub. No.: US 2025/0189003 A1
(43) Pub. Date: Jun. 12, 2025

(54) DRUM BRAKE

(71) Applicants: Daejune JUNG, Gyeonggi-do (KR); Pyeongkook SON, Gyeonggi-do (KR)

(72) Inventors: Daejune JUNG, Gyeonggi-do (KR); Pyeongkook SON, Gyeonggi-do (KR)

(73) Assignee: HL MANDO CORPORATION, Gyeonggi-do (KR)

(21) Appl. No.: 18/885,658

(22) Filed: Sep. 15, 2024

(30) Foreign Application Priority Data
Dec. 11, 2023 (KR) 10-2023-0179148

(51) Int. Cl. F16D 65/22; F16D 51/22; F16D 66/00; F16D 121/24; F16D 125/40; F16D 125/52

(52) U.S. Cl. CPC F16D 65/22; F16D 51/22; F16D 2066/005; F16D 2121/24; F16D 2125/40; F16D 2125/52

(57) ABSTRACT

A drum brake includes: a motor providing rotational driving force; a pair of pressing units pressing a pair of brake shoes onto an inner peripheral surface of a drum; and a power transmission unit transmitting the rotational driving force of the motor to the pressing unit, and the power transmission unit includes a rotational member which rotates by receiving the rotational driving force of the motor, and a rotational screw which is coupled to the rotational member, and advances and retreats onto the inner peripheral surface of the drum.

### CROSS-REFERENCE TO RELATED APPLICATION

This application claims the priority of Korean Patent Application No. 10-2023-0179148 filed on Dec. 11, 2023, in the Korean Intellectual Property Office, the disclosure of which is incorporated herein by reference in its entirety.

### BACKGROUND

### Field

The present disclosure relates to a drum brake, and more particularly, to a drum brake that implements miniaturization and precise control of an electro-mechanical drum brake.

### Description of the Related Art

A brake system for performing braking is requisitely mounted on a vehicle, and various types of brake systems are proposed for the safety of drivers and passengers.

A drum brake as one of the brake systems utilizes frictional force through a contact of a drum and a brake shoe as braking force.

A drum brake in related art generates the braking force of the vehicle by a scheme of supplying fluid pressure to a wheel cylinder through a mechanically connected booster when the driver steps on a brake pedal.

However, today, a next-generation brake system generates the braking force of the vehicle by receiving a braking willingness of the driver into an electrical signal and electrically actuating a power transmission device such as a motor in parking brake and regular brake situations.

Such a brake is referred to as an electro-mechanical brake (EMB), and the drum brake is referred to as an electro-mechanical drum brake.

In recent years, a demand for electro-mechanical brake which electrically operates without hydraulic pressure continues to increase as a market share of electric vehicles or autonomous vehicles is increasing,

In addition, the drum brake has an advantage in terms of weight and price compared to a caliper brake, so there is also a need to replace the caliper brake with the drum brake.

At this time, in order to replace, with the electro-mechanical drum brake, the caliper brake which is utilized in a small vehicle in the related art, a drum brake with a small enough size is required.

However, the electro-mechanical drum brake in the related art has a problem in which a component is added for precise control, and the interior of the brake becomes complicated, and as a result, there is a limit in reducing the size of the brake.

Therefore, the electro-mechanical drum brake of the present disclosure suggests a measure to effectively reduce the volume of the brake by placing internal components of the brake space-intensively while implementing the precise control of the brake.

### SUMMARY

An object to be achieved by an exemplary embodiment of the present disclosure is to provide a drum brake electro-mechanically driven so as to perform roles of a parking brake and a service brake by one device.

Another object to be achieved by an exemplary embodiment of the present disclosure is to provide a drum brake which is enabled to be precisely controlled.

Yet another object to be achieved by an exemplary embodiment of the present disclosure is to provide a drum brake which may measure force of a brake shoe applied to an inner peripheral surface of a drum.

Still yet another object to be achieved by an exemplary embodiment of the present disclosure is to provide a drum brake which is miniaturized.

Still yet another object to be achieved by an exemplary embodiment of the present disclosure is to provide a drum brake which intensively utilizes a space through efficient placement of components.

Still yet another object to be achieved by an exemplary embodiment of the present disclosure is to provide a drum brake with enhanced assemblability and economics.

According to an aspect of the present disclosure, a drum brake includes: a motor providing rotational driving force; a pair of pressing units pressing a pair of brake shoes onto an inner peripheral surface of a drum; and a power transmission unit transmitting the rotational driving force of the motor to the pressing unit, and the power transmission unit includes a rotational member which rotates by receiving the rotational driving force of the motor, and a rotational screw which is coupled to the rotational member, and advances and retreats onto the inner peripheral surface of the drum, and the pressing unit includes a first pressing member disposed on one end of the rotational screw and pressing the brake shoe onto the inner peripheral surface of the drum by axial force of the rotational screw, and a force sensor disposed between the rotational screw and the first pressing member, and measuring force pressed to the first pressing member.

The first pressing member and the force sensor may be formed to be slidably movable in an advance and retreat direction of the rotational screw.

The first pressing member may include an accommodation space therein, and the force sensor may be disposed in the accommodation space.

The accommodation space may be formed in a longitudinal direction of the rotational screw so that the force sensor is slidably movable.

The first pressing member may include a floor portion in which one side is formed to be in contact with the force sensor, and a wing portion extended in the longitudinal direction of the rotational screw on a circumference of the floor portion so that the other side is opened.

The force sensor may include a protrusion portion which protrudes to the first pressing member.

The force sensor may further include an electrical line connected to a side surface and wiredly transmitting the obtained information.

A hole may be formed to penetrate on a side surface of the first pressing member, and the electrical line may be provided to pass through the hole.

The hole may be disposed below the first pressing member, and the electrical line may be disposed below the force sensor.

The hole may be formed in the longitudinal direction of the rotational screw so that the electrical line is slidably movable jointly with the force sensor.

The hole may be provided with one side being opened.

The power transmission unit may include a first gear coupled to a rotational shaft of the motor, a second gear engaged with the first gear, a third gear formed on an outer peripheral surface of the rotational member, and a transmission shaft extended along the rotational shaft of the second gear and transmitting the rotational force of the second gear to the third gear.

The third gear may be a worm gear, and a worm engaged with the third gear may be formed on an outer peripheral surface of a distal end of the transmission shaft.

The rotational member may be provided as a ball nut coupled to the rotational screw.

The drum brake may further include a guide housing in which the power transmission unit may be installed and supported therein, and the power transmission unit may further include a pair of bushes disposed at both sides of the third gear and provided in a ring shape to support the outer peripheral surface of the third gear and the inner peripheral surface of the guide housing.

The bush may include a first bush disposed at the first pressing member, and a second bush disposed at an opposite side to the first pressing member, and the power transmission unit may further include a stopper disposed between the first bush and the first pressing member.

The guide housing may further include a stopper groove dented in a radial direction on the inner peripheral surface, and the stopper may be formed in a C shape and seated on the stopper groove.

The power transmission unit may further include a thrust bearing disposed between the rotational member and the first pressing member.

The drum brake may further include a third bush disposed between the rotational member and the thrust bearing.

According to another aspect of the present disclosure, a drum brake includes: a motor providing rotational driving force; a pair of pressing units pressing a pair of brake shoes onto an inner peripheral surface of a drum; a power transmission unit transmitting the rotational driving force of the motor to the pressing unit; a force sensor disposed inside the pressing unit and measuring force pressed to a first pressing member; and a control unit controlling the motor based on information obtained from the force sensor through an electrical line electrically connected to the force sensor.

An exemplary embodiment of the present disclosure provides a drum brake electro-mechanically driven so as to perform roles of a parking brake and a service brake in one device.

An exemplary embodiment of the present disclosure provides a drum brake which is enabled to be precisely controlled.

An exemplary embodiment of the present disclosure provides a drum brake which may measure force of a brake shoe applied to an inner peripheral surface of a drum.

An exemplary embodiment of the present disclosure provides a drum brake which is miniaturized.

An exemplary embodiment of the present disclosure provides a drum brake which intensively utilizes a space through efficient placement of components.

An exemplary embodiment of the present disclosure provides a drum brake with enhanced assemblability and economics.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating a drum brake;

FIG. 2 is a perspective view illustrating a part of a drum brake according to an exemplary embodiment of the present disclosure;

FIG. 3 is a perspective view illustrating a power transmission unit of the drum brake according to an exemplary embodiment of the present disclosure;

FIG. 4 is a perspective view illustrating an interior of the power transmission unit of the drum brake according to an exemplary embodiment of the present disclosure;

FIG. 5 is a perspective view illustrating a first pressing member according to an exemplary embodiment of the present disclosure;

FIG. 6 is a perspective view illustrating a state in which a force sensor connected to an electrical line is additionally coupled in FIG. 5;

FIG. 7 is a perspective view illustrating a state in which a thrust bearing, a third bush, and a stopper are additionally coupled in FIG. 6;

FIG. 8 is a perspective view illustrating a state in which a rotational member, a rotational screw, a third gear, a thrust bearing, a first bush, a second bush, and a third bush are additionally coupled in FIG. 7; and

FIG. 9 is a perspective view illustrating a state in which a second pressing member is additionally coupled in FIG. 8.

### DETAILED DESCRIPTION OF THE EMBODIMENT

Hereinafter, the exemplary embodiment will be described in detail with reference to the accompanying drawings. The following exemplary embodiment is to fully present the idea of the present disclosure to those skilled in the art to which the present disclosure pertains. The present disclosure is not limited to exemplary embodiments described presented herein and may be embodied in other forms. In the drawings, illustration of parts not related to the description will be omitted to clarify the present disclosure, and the size of a component may be slightly exaggerated and expressed to help understanding.

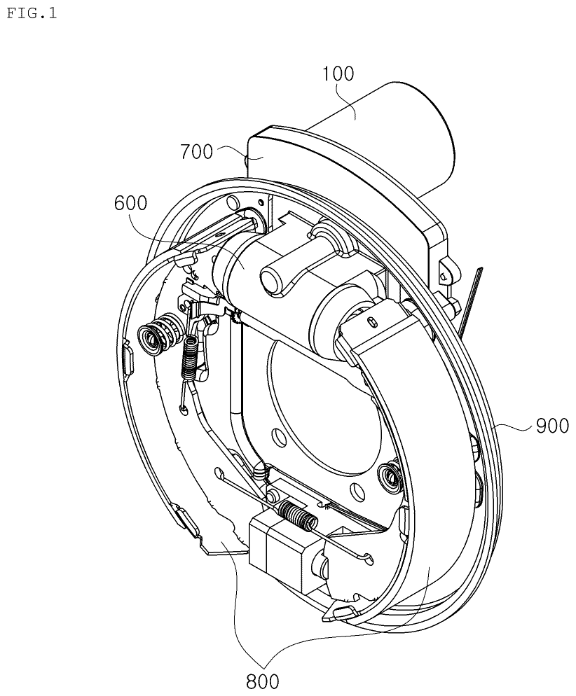

FIG. 1 is a perspective view illustrating a drum brake.

Referring to FIG. 1, the drum brake as an electro-mechanical brake includes a drum and a backplate 900, and includes a brake shoe 800 which is rubbed against the drum to generate braking force of a brake, a motor 100 for driving the brake shoe 800, a housing including the motor 100 and a power transmission unit 300 for transmitting rotation driving force of the motor 100 to the brake shoe 800, and a guide housing 600.

The drum (not illustrated) is a cylindrical component attached to a wheel hub. The drum (not illustrated) rotates jointly with a wheel, and has a frictional surface which is rubbed against the brake shoe 800 therein. Accordingly, when the brake requires braking, a pair of brake shoes 800 is compressed on an inner peripheral surface of the drum (not illustrated) to generate friction, and such braking force is utilized as the braking force. The drum (not illustrated) is primarily made of iron or cast iron.

The brake shoes 800 are provided as a pair, and disposed inside the drum to be opposite to each other. At this time, the brake shoe 800 is provided to rotate to be rubbed against the drum. Accordingly, when a driver steps on a brake pedal, each of a pair of brake shoes 800 moves to the inner peripheral surface of the drum and is rubbed against the frictional surface of the drum.

In respect to the brake shoe 800, in general, a brake shoe 800 positioned in front of a driving direction is generally referred to as a leading shoe and a brake shoe 800 positioned in the rear of the driving direction is referred to as a trailing shoe.

The motor 100 electronically operates to provide rotational driving force in one direction or the other direction. As an example, the motor 100 may be a brushless AC motor 100 having a high output. However, the type of motor 100 of the present disclosure is not limited.

The motor 100 is connected to a control unit embedded in a vehicle, and an operation of the motor 100 is controlled. That is, the control unit receives a movement distance of the brake pedal manipulated by the driver as information, and controls the motor 100 based on the movement distance to control a level at which the brake shoe 800 is pressurized onto the inner peripheral surface of the drum.

The housing 700 is disposed in rear of the top of the drum, and the guide housing 600 is disposed in front of the top of the drum. The motor 100 and the power transmission unit 300 are installed and supported inside the housing 700, and the power transmission unit 300 is installed and supported inside the guide housing 600.

Specifically, components that directly transmit rotational force of the motor 100 in the power transmission unit 300 are disposed inside the housing 700, and components that switch and provide a rotational motion of the motor 100 into a translational motion in the power transmission unit 300 are disposed inside the guide housing 600. Detailed components of the power transmission unit 300 will be described later in detail.

The backplate 900 is primarily made of a metallic material, and the drum, the brake shoe 800, the housing 700, and the guide housing 600 are installed and supported. At this time, a pair of brake shoes 800 maintains a predetermined distance from each other, and is installed and supported in front of the backplate 900 to be rotatable.

In the electro-mechanical drum brake in the related art may include a sensor that measures force of the brake shoe 800 applied onto the inner peripheral surface of the drum for precise control.

However, in the electro-mechanical drum brake in the related art, the sensor is provided while occupying a separate space inside the brake, so there is a limit in reducing the volume of the drum brake.

In particular, the caliper brake is applied to most small vehicles, and the electro-mechanical drum brake in the related art is limited in miniaturization, so there is a problem in that the caliper brake may not be replaced with the electro-mechanical drum brake in the related art.

Accordingly, in the present disclosure, the sensor which exists inside the electro-mechanical drum brake is space-intensively placed to solve the problem of the electro-mechanical drum brake in the related art so that the brake is enabled to be precisely controlled, and miniaturized.

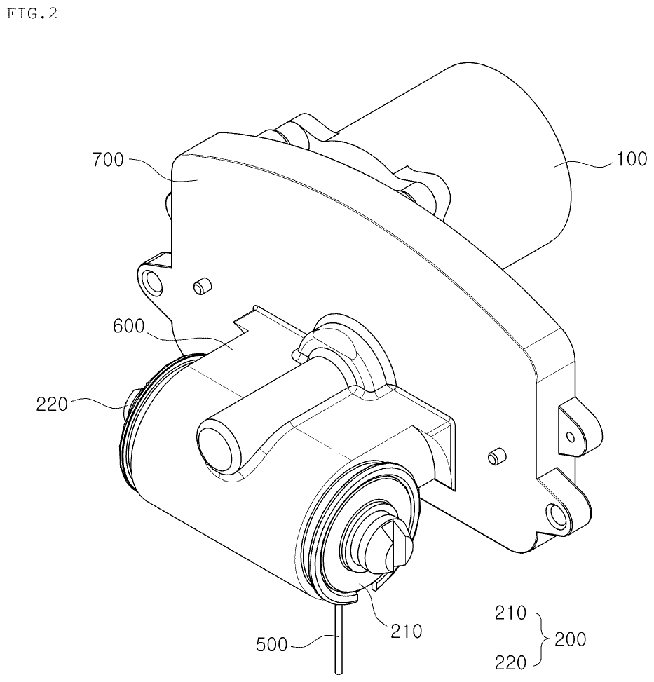

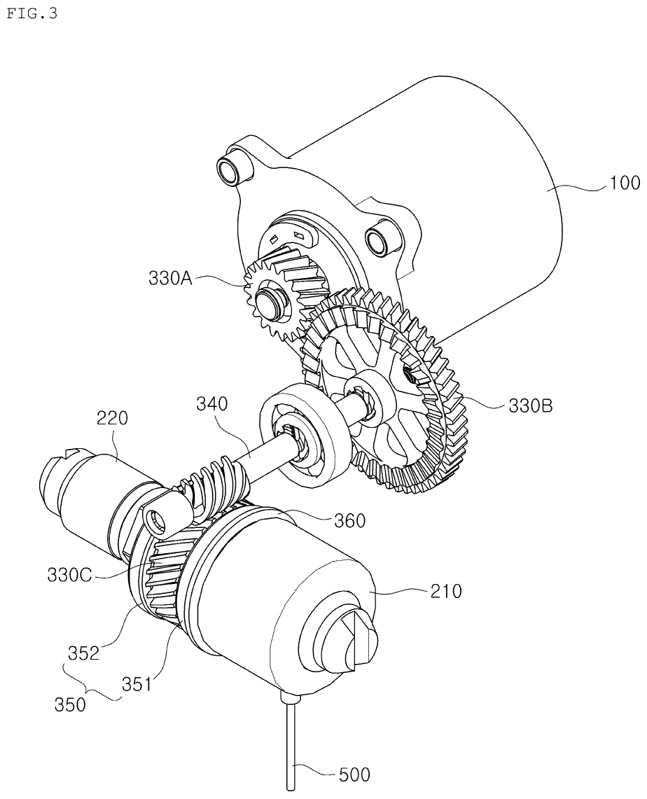

FIG. 2 is a perspective view illustrating a part of a drum brake according to an exemplary embodiment of the present disclosure, and FIG. 3 is a perspective view illustrating a power transmission unit 300 of the drum brake according to an exemplary embodiment of the present disclosure.

Referring to FIGS. 2 and 3, the drum brake according to an exemplary embodiment of the present disclosure includes a motor 100, a pressing unit 200 receiving rotational driving force of the motor 100 and pressing the brake shoe 800 to the drum, a housing 700 and a guide housing 600 including the motor 100 and a power transmission unit 300 transmitting the rotational driving force of the motor 100 to the brake shoe 800, and an electrical line 500 connected to a force sensor 400 measuring the force applied to the pressing unit 200.

The housing 700 includes components of the motor 100 and the power transmission unit 300 transmitting the rotational force of the motor 100. In the motor 100, a rotational shaft may be disposed to face a front and a rear to be disposed to be perpendicular to a direction in which the pressing unit 200 advances and retreats as in FIG. 2, and disposed to be in line with the advance and retreat direction of the pressing unit 200 unlike FIG. 2.

The guide housing 600 includes components of the power transmission unit 300 which receive a rotational motion of the power transmission unit 300 provided in the housing 700 and switch the rotational motion into a translational motion, and a pair of pressing units 200 pressing a pair of brake shoes 800 onto an inner peripheral surface of the drum through the translational motion.

The pressing unit 200 includes a first pressing member 210 provided at one side and measuring pressure pressurized from the force sensor 400, and a second pressing member 220 provided at the other side of the pressing member 200.

The force sensor 400 provided at the first pressing member 210 has the electrical line 500 to be electrically connected to the control unit. The first pressing member 210, the force sensor 400, and the control unit will be described later in detail.

Referring to FIG. 3, the drum brake according to an exemplary embodiment of the present disclosure includes the motor 100, the power transmission unit 300 transmitting the rotational driving force of the motor 100 to the brake shoe 800, and the pressing unit 200 moving through the power transmission unit 300 and pressing the brake shoe 800.

The power transmission unit 300 transmits the rotational driving force of the motor 100 to the pressing unit 200. The power transmission unit 300 includes a first gear 330A, a second gear 330B, a third gear 330c, and a transmission shaft 340 transmitting the rotational motion of the motor 100.

The first gear 330A is coupled to the rotational shaft of the motor 100. Accordingly, the first gear 330A has the same rotational shaft as the motor 100.

The second gear 330B has a rotational shaft spaced apart by a predetermined distance from and disposed in parallel to the rotational shaft of the first gear 330A. When the second gear 330B is engaged with the first gear 330A, and the first gear 330A rotates, the second gear 330B also receives the rotational force of the first gear 330A, and rotates jointly.

The first gear 330A and the second gear 330B may be provided as a helical gear. Accordingly, noise caused by engagement of the first gear 330A and the second gear 330B may be minimized.

However, the first gear 330A and the second gear 330B are not limited to a specific gear type and a specific gear size, and as long as the first gear 330A may transmit the rotational force of the motor 100 to the second gear 330B, the first gear 330A and the second gear 330B include all gears including a spur gear.

The transmission shaft 340 is extended along the rotational shaft of the second gear 330B. That is, the transmission shaft 340 has a rotational axis which is the same as the rotational shaft of the second gear 330B, and is extended to the front and rear.

The transmission shaft 340 may include a ball bearing at the center thereof. The ball bearing may support the 340 transmission shaft 340 so that the transmission shaft extended long to the front and rear may stably rotate.

The transmission shaft 340 is engaged with the third gear 330c, and transmits the rotational force of the second gear 330B to the third gear 330C.

The third gear 330C is a worm gear, and a worm engaged with the third gear 330C is formed on an outer peripheral surface at a distant end of the transmission shaft 340.

Accordingly, the third gear 330C may have a rotational shaft perpendicular to the rotational shaft of the transmission shaft 340, and the transmission shaft 340 and the third gear 330C transmit the rotational force of the motor 100 through coupling the worm and the worm gear to minimize noise caused by engagement of the transmission shaft 340 and the third gear 330C.

However, the transmission shaft 340 and the third gear 330C are not limited to a specific gear type and a specific gear size, and the transmission shaft 340 and the third gear 330C include all gears that the transmission shaft 340 may transmit the rotational force to the third gear 330C having the perpendicular rotational shaft.

Meanwhile, the third gear 330C is coupled to the rotational member 310 to rotate the rotational member 310, and a bush 350 and a stopper 360 are provided around the third gear 330C.

The rotational member 310 rotated by the third gear 330C makes a rotational screw 320 to perform the translational motion, and thus, the rotational screw 320 presses the pressing unit 200 onto the inner peripheral surface of the drum. The rotational member 310, the rotational screw 320, the bush 350, and the stopper 360 will be described later in detail.

There are a pair of pressing units 200. The pressing unit 200 includes a first pressing member 210 disposed on one end of the rotational screw 320 and pressing the brake shoe 800 onto the inner peripheral surface of the drum by axial force of the rotational screw 320, and a second pressing member 220 provided on the other end.

Both the first pressing member 210 and the second pressing member 220 may have protrusions which protrude toward the brake shoe 800 adjacent thereto. The respective protrusions are coupled to the top of the brake shoe 800 adjacent thereto to easily move the brake shoe 800 to the inner peripheral surface of the drum.

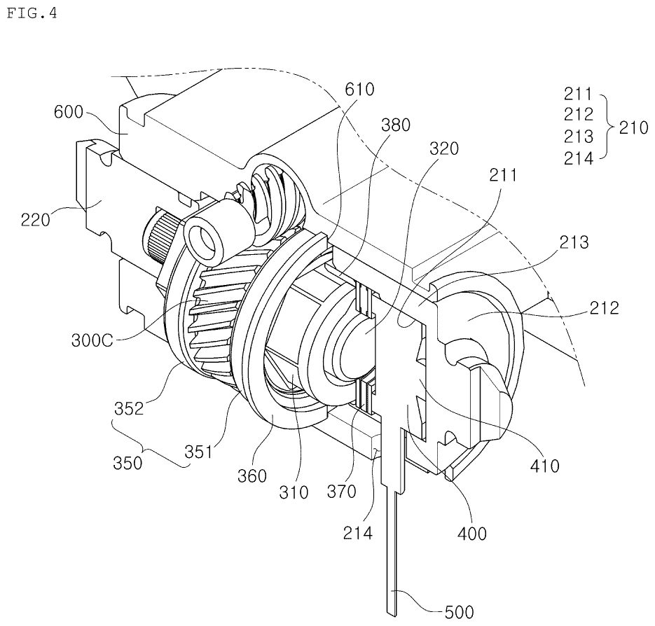

FIG. 4 is a perspective view illustrating an interior of the power transmission unit 300 of the drum brake according to an exemplary embodiment of the present disclosure.

Referring to FIG. 4, the drum brake according to an exemplary embodiment of the present disclosure includes the motor 100, the components of the power transmission unit 300 related to the translational motion in the power transmission unit 300 for transmitting the rotational driving force of the motor 100 to the brake shoe 800, the pressing unit 200 moving through the power transmission unit 300 and pressing the brake shoe 800, the force sensor 400 measuring the force applied pressed to the pressing unit 200, and the electrical line 500 connected to the force sensor 400.

The rotational member 310 rotates by receiving the rotational driving force of the motor 100.

Specifically, when the motor 100 rotates, the transmission shaft 340 rotates by means of the first gear 330A and the second gear 330B, and when the transmission shaft 340 rotates, the third gear 330C rotates. At this time, the outer peripheral surface of the rotational member 310 is coupled to the inner peripheral surface of the third gear 330C, so the rotational member 310 rotates jointly with the third gear 330C.

The outer peripheral surface of the rotational member 310 and the inner peripheral surface of the third gear 330C may be coupled to each other with cross-sections being provided in the same polygonal shape as illustrated in FIG. 4.

Accordingly, when the rotational member 310 is inserted into the third gear 330C and the rotational member 310 rotates, the rotational member 310 may also rotate jointly with the third gear 330C while the polygonal cross sections are engaged with each other.

However, shapes of the outer peripheral surface of the rotational member 310 and the inner peripheral surface of the third gear 330C are not limited to a specific shape, and as long as the rotational force of the third gear 330C may be transmitted to the rotational member 310, the shapes include all shapes including a sawtooth shape.

The rotational screw 320 is coupled to the rotational member 310 to advance and retreat onto the inner peripheral surface of the drum.

Specifically, when the rotational member 310 rotates, the rotational screw 320 performs the translational motion, and the rotational screw 320 presses the first pressing member 210 and the second pressing member 220 provided at both sides onto the inner peripheral surface of the drum.

The bush 350 reduces friction generated when the third gear 330C rotates to enhance the durability of the third gear 330C.

Specifically, the bush 350 prevents the third gear 330C from generating the wear and tear caused by the direct contact with the inner peripheral surface of the guide housing 600 when the third gear 330C rotates.

A pair of bushes 350 is provided and disposed at both sides of the third gear 330C. The bush 350 is provided in a ring shape to support the outer peripheral surface of the third gear 330C and the inner peripheral surface of the guide housing 600 and provided to surround both sides of the third gear 330C.

The bush 350 includes a first gush 351 disposed at the first pressing member 210 and a second bush 352 disposed at an opposite side to the first pressing member 210.

The stopper 360 is disposed between the first bush 351 and the first pressing member 210.

The guide housing 600 may include a stopper groove 610 dented on the inner peripheral surface in a radial direction, and the stopper 360 may be seated on the stopper groove 610.

The stopper 360 supports one surface of the first push 351 to prevent the first bush 351 from being separated to the first pressing member 210.

The stopper 360 may be formed in a C shape. A hole is provided at a distal end of the stopper 360 formed in the C shape, and a protrusion is provided on one surface of the first bush 351 to enhance the assemblability of both components.

The first pressing member 210 and the second pressing member 220 are coupled to one side and the other side of the rotational screw 320, respectively. A specific shape and a specific feature of the first pressing member 210 will be described later in detail.

The thrust bearing 370 is disposed between the rotational member 310 and the first pressing member 210 to support a load according to the axial force of the rotational screw 320.

The third bush 380 reduces friction generated when the rotational member 310 rotates to enhance the durability of the rotational member 310.

Specifically, the bush 350 prevents the rotational member 310 from generating the wear and tear caused by the direct contact with the inner peripheral surface of the first pressing member 210 when the rotational member 310 rotates.

The third bush 380 is disposed between the rotational member 310 and the thrust bearing 370.

The third bush 380 is provided in a ring shape to support the outer peripheral surface of the rotational member 310 and the inner peripheral surface of the first pressing member 210 and provided to surround the distal end of the first pressing member 210.

At this time, a length of the third bush 380 is provided to sufficiently surround the distal end of the first pressing member 210 by considering a distance at which the first pressing member 210 advances and retreats.

The force sensor 400 measures the force pressed to the first pressing member 210. The force sensor 400 is disposed between the rotational screw 320 and the first pressing member 210.

Specifically, the first pressing member 210 may include an accommodation space 211 therein as illustrated in FIG. 4, and the force sensor 400 may be disposed in the accommodation space 211.

Accordingly, a separate installation space for the force sensor 400 is not required inside the drum brake to prevent the volume from being increased as the drum brake includes the force sensor 400.

The force sensor 400 may include a protrusion portion 410 which protrudes to the first pressing member 210. The protrusion portion 410 may be formed to have a central axis which is the same as a central axis of the rotational screw 320. At this time, a periphery of the protrusion portion 410 may be dented inward.

The force sensor 400 may include a dented portion which is dented at an opposite side to the first pressing member 210. The dented portion may have a similar size to a distal end surface of the rotational screw 320.

The first pressing member 210 and the force sensor 400 may be formed to be slidably moveable in the advance and retreat direction of the rotational screw 320. Further, the accommodation space 211 provided in the first pressing member 210 may be formed in a longitudinal direction of the rotational screw 320 so that the force sensor 400 is slidably movable.

Accordingly, when the motor 100 rotates in a forward direction, the rotational screw 320 moves forward to the brake shoe 800 to press the force sensor 400. Accordingly, the force sensor 400 slidably moves in the first pressing member 210 to press the first pressing member 210, and the first pressing member 210 slidably moves in the guide housing 600 to press the brake shoe 800.

The electrical line 500 electrically connects the force sensor 400 and the control unit. The electrical line 500 may be connected to a side surface of the force sensor 400.

The electrical line 500 is provided to penetrate a hole 214 provided in the first pressing member 210 to move according to a motion of the first pressing member 210.

A coat of a portion of the electrical line 500, which penetrates the hole 214, may be provided to be thick. Accordingly, when the electrical line 500 is rubbed against the hole 214 while moving jointly with the first pressing member, it is possible to prevent degradation of durability due to the wear and tear caused by this. The shape of the first pressing member 210 will be described later in detail.

The electrical line 500 may be connected to a rear surface of the backplate 900 by penetrating the backplate 900.

Accordingly, the electrical line 500 may be connected to installed at a rear of the a control unit (not illustrated) backplate 900. In this case, an influence of frictional heat and vibration generated by the friction of the drum and the brake shoe 800 may be minimized in a process in which information collected by the force sensor 400 is transmitted to the control unit (not illustrated) through the electrical line 500.

The control unit (not illustrated) controls the motor 100 based on the information obtained from the force sensor 400 through the electrical line 500 electrically connected to the force sensor 400.

Specifically, the force sensor 400 measures the force applied to the first pressing member 210 and makes a measurement result into data. The data is referred to as first information.

The force sensor 400 may convert the first information into an electrical signal, and transmit the electrical signal to the control unit (not illustrated). The first information may contain detailed configurations of the power transmission units 300 and the pressing units 200, and characteristics of the brake shoe 800.

The control unit (not illustrated) may receive, from the motor 100, information on a magnitude of current which flows on the motor 100. The information is referred to as second information.

The second information does not contain the detailed configurations of the power transmission units 300 and the pressing units 200, and the characteristics of the brake shoe 800.

A data storage space is provided in the control unit (not illustrated), and information recorded in the data storage space is referred to as third information. The third information may be a set of data related to the magnitude of the current which flows on the motor 100, a magnitude of the force applied by the first pressing member, and the resulting magnitude of actual braking force. The third information may mean information transmitted from another component related to the control.

The control unit (not illustrated) may compare the transmitted first information and second information with the third information, and derive estimated braking force based on a comparison result.

Since the control unit (not illustrated) may use the first information containing characteristics of the drum brake, the control unit (not illustrated) may more accurately estimate the braking force of the brake.

The control unit (not illustrated) may derive input braking force.

As an example, when the driver manipulates the brake pedal, the control unit (not illustrated) may measure a spacing degree of the brake pedal, and determine the input braking force based on the measured spacing degree.

The control unit (not illustrated) may compare the estimated braking force and the input braking force. The control unit (not illustrated) may control the motor 100 based on a comparison result of the input braking force and the estimated braking force.

Specifically, when a magnitude of the estimated braking force is smaller than a magnitude of the input braking force, the control unit (not illustrated) controls more current to flow on the motor 100 to increase an output of the motor 100.

On the contrary, when the magnitude of the estimated braking force is larger than the magnitude of the input braking force, the control unit (not illustrated) controls less current to flow on the motor 100 to decrease the output of the motor 100.

The control unit (not illustrated) may control the motor 100 so that a difference between the estimated braking force and the input braking force gradually decreases by repeatedly performing such a process.

Accordingly, the control unit (not illustrated) utilizes the information containing the characteristics of the drum brake as the basis for the control, and repeatedly performs the process through force feedback to more precisely control the braking force of the brake.

Hereinafter, the components which perform the translational motion in the power transmission unit 300 will be described in detail.

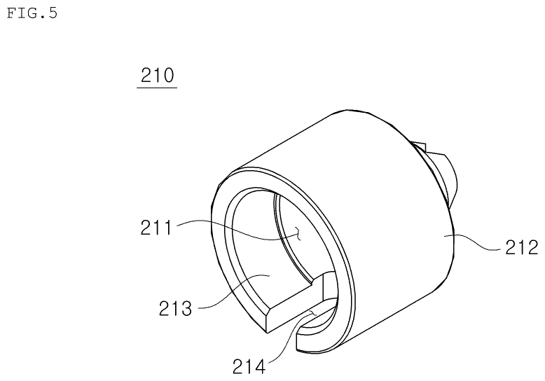

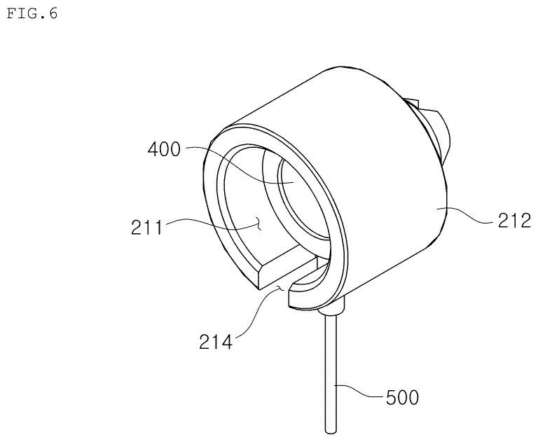

FIG. 5 is a perspective view illustrating a first pressing member 210 according to an exemplary embodiment of the present disclosure, and FIG. 6 is a perspective view illustrating a state in which a force sensor 400 connected to an electrical line 500 is additionally coupled in FIG. 5.

Referring to FIGS. 5 and 6, the drum brake according to an exemplary embodiment of the present disclosure includes a first pressing member 210 provided in a cylindrical shape having the accommodation space 211 therein and having one side which is opened, and a force sensor 400 disposed in the accommodation space 211 of the first pressing member 210.

The first pressing member 210 includes a floor portion 212 and a wing portion 213 so that the accommodation space is provided therein, and a hole 214 is formed in the wing portion 213 of the first pressing member 210 so that the electrical line 500 connected to the force sensor 400 may arbitrarily move inside the first pressing member.

The floor portion 212 forms a floor so that one side of the first pressing member 210 may be in contact with the force sensor 400. A surface of the floor portion 212, which is in contact with the force sensor 400, may be provided to be flat, and a surface which is not in contact with the force sensor 400 has a protrusion to easily move the brake shoe 800 onto the inner peripheral surface of the drum.

The wing portion 213 forms a side surface so that the accommodation space 211 accommodating the force sensor 400 may be provided inside the first pressing member 210. The wing portion 213 is extended in a longitudinal direction of the rotational screw 320 on a circumference of the floor portion 212 so that the other side of the first pressing member 210 is opened.

The wing portion 212 may have a step at the center of the inner side. That is, the wing portion 213 may be extended with a predetermined section toward the rotational screw 320, and the step may be formed so that an outer diameter of the accommodation space 211 increases, and then extended toward the rotational screw 320 again.

In this case, the force sensor 400 is disposed in a section where an outer diameter of the accommodation space 211 is small, and the thrust bearing 370 is disposed in a section where the outer diameter of the accommodation space 211 is large.

Accordingly, when the first pressing member 210 retreats, the force sensor 400 may slidably move and the thrust bearing 370 may support the load of the force sensor 400, and on the contrary, when the first pressing member 210 moves forward, the thrust bearing 370 is restricted from moving by the step, so the force sensor 400 may accurately measure the force of the rotational member 310 which presses the first pressing member 210.

The hole 214 is penetrated on the side surface of the first pressing member 210. That is, the hole 214 is penetrated at the wing portion 213 of the first pressing member 210. Accordingly, the electrical line 500 may be provided to pass through the hole 214.

The hole 214 may be disposed below the first pressing member 210, and the electrical line 500 may be disposed below the force sensor 400.

The hole 214 may be disposed on the backplate 900 in the first pressing member 210, and the electrical line 500 may be disposed on the backplate 900 in the force sensor 400. At this time, when the control unit (not illustrated) is provided on a rear surface of the backplate 900, the force sensor 400 and the control unit (not illustrated) may be electrically connected to the short electrical line 500.

However, a layout structure of the hole 214 and the electrical line 500 is not limited to a lower side, and includes all layout structures in which the electrical line 500 connected to the force sensor 400 may be extended to outside the first pressing member 210 by passing through the hole 214 of the first pressing member 210.

The guide housing 600 may include a through-hole provided at a point corresponding to the hole 214. Accordingly, the electrically line 500 may primarily penetrate the first pressing member 210 through the hole 214, and secondarily penetrate the guide housing 600 through the through-hole.

The hole 214 may be formed in the longitudinal direction of the rotational screw 320 so that the electrical line 500 is slidably movable jointly with the force sensor 400.

The hole 214 may be provided so that one side is opened. Accordingly, the electrical line 500 may be easily assembled to the first pressing member 210. At this time, the other side of the hole 214 is formed to be rounded to prevent the wear and tear of the electrical line 500.

The through-hole of the guide housing 600 may also be formed in the longitudinal direction of the rotational screw 320 and provided with one side opened like the hole 214.

However, when a direction in which the hole 214 is opened is an opposite side to the brake shoe 800, a direction in which the through hole is opened may be at the side of the brake shoe 800.

Accordingly, the force sensor 400 may be disposed inside the first pressing member 210, and may slidably move in the advance and retreat direction according to a braking state of the brake, and the electrical line 500 connected to the force sensor 400 is provided to arbitrarily move jointly with the movement of the force sensor 400, so components are efficiently placed and an internal space of the brake is intensively utilized, and as a result, the volume of the drum brake is prevented from being increased to assist miniaturization.

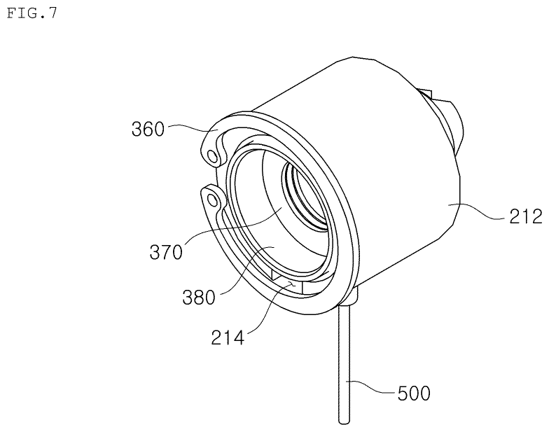

FIG. 7 is a perspective view illustrating a state in which a thrust bearing 370, a third bush 380, and a stopper 360 are additionally coupled in FIG. 6.

Referring to FIG. 7, it can be seen that in the drum brake according to an exemplary embodiment of the present disclosure, the thrust bearing 370, the third bush 380, and the stopper 360 are sequentially installed in the first pressing member 210 in which the force sensor 400 is installed.

The thrust bearing 370 is provided in such a manner that one surface supports the rotational member 310 and the other surface supports the force sensor 400, and the through-hole 214 is provided at the center, so the rotational screw 320 may pass through the thrust bearing 370.

The third bush 380 is disposed in contact with an edge of one surface of the thrust bearing 370.

The stopper 360 is provided to be in contact with the distal end of the wing portion 213 of the first pressing member 210, and is made of an elastic material to serve to fix a location of the first bush 351 and buffer an impact generated when the first pressing member 210 retreats.

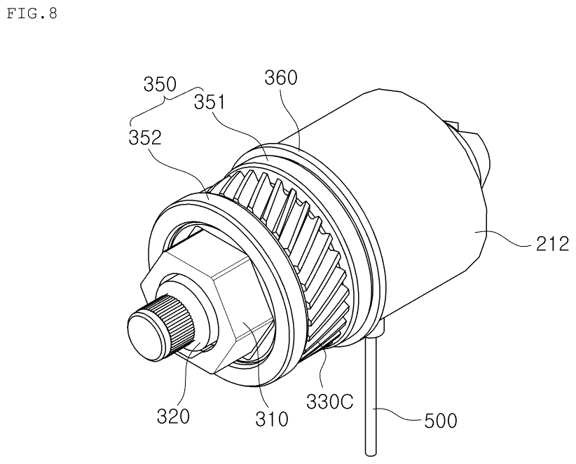

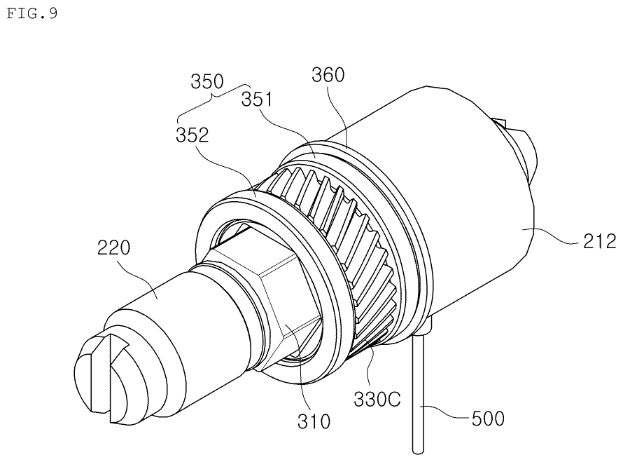

FIG. 8 is a perspective view illustrating a state in which a rotational member 310, a rotational screw 320, a third gear 330C, a thrust bearing 370, a first bush 351, a second bush 352, and a third bush 380 are additionally coupled in FIG. 7, and FIG. 9 is a perspective view illustrating a state in which a second pressing member 220 is additionally coupled in FIG. 8.

Referring to FIGS. 8 and 9, it can be seen that in the drum brake according to an exemplary embodiment of the present disclosure, the bush 350, the third gear 330C, the rotational member 310, the rotational screw 320, and the second pressing member 220 are sequentially installed in the first pressing member 210.

The bush 350 includes a first gush 351 disposed at the first pressing member 210 and a second bush 352 disposed at an opposite side to the first pressing member 210.

The bush 350 may prevent the third gear 330C from being in direct contact with the inner peripheral surface of the guide housing 600 when the third gear 330C rotates, and allows the worm of the transmission shaft 340 and the worm gear of the third gear 330C not to be fully closely attached and engaged, but to be engaged to be spaced apart from each other by a predetermined distance to prevent the transmission shaft 340 and the third gear 33C from generating the wear and tear.

The rotational member 310 is provided as a ball nut and the rotational screw 320 is provided as a ball screw, so both components may be coupled by the ball screw and the ball nut.

In the ball-screw and nut coupling as coupling primarily used in machine driving requiring precise motion, when the screw rotates, the ball advances or retreats the nut while moving inside a nut groove.

Accordingly, with respect to the rotational member 310 and the rotational screw 320, since backlash of the rotational screw 320 becomes smaller than that of general screw coupling, it is possible to control the brake more precisely, and even though dust enters between the rotational screw 320 and the rotational member 310, damage to both components is small, so durability is enhanced.

However, a coupling scheme of the rotational member 310 and the rotational screw 320 is not limited to the ball-screw and nut coupling, but includes all coupling schemes in which the rotational screw 320 may perform the translational motion according to rotation of the rotation member 310.

The second pressing member 220 may be provided to have a smaller volume than the first pressing member 210 accommodating the force sensor 400. The second pressing member 220 has the protrusion at the adjacent brake shoe 800 like the first pressing member 210 to easily press the brake shoe 800. The protrusion has a groove vertically dented to be stably coupled to the top of the brake shoe 800.

As such, the drum brake according to an exemplary embodiment of the present disclosure includes the motor 100, the pressing unit 200 and the power transmission unit 300 to perform roles of the parking brake and the service brake to be driven electro-mechanically in one device.

Further, the drum brake includes the force sensor 400 to measure the force pressed to the pressing unit 200, and the control unit (not illustrated) may precisely control the brake by performing force feedback based on the information of the force sensor 400.

In particular, the force sensor 400 is disposed between the rotational screw 320 and the first pressing member 210, and more specifically, the force sensor 400 is disposed in the internal accommodation space 211 of the first pressing member 210, so the components are efficiently disposed and the space is intensively utilized to enable miniaturization of the brake.

Therefore, the components of the drum brake are reduced, the assemblability is enhanced, and economics is enhanced, of course.

While the present disclosure has been described in connection with what is presently considered to be practical exemplary embodiments, it is to be understood that the present disclosure is not limited to the disclosed exemplary embodiments, but, on the contrary, is intended to cover various modifications within the technical idea of the present disclosure and an equivalent range of the appended claims.

What is claimed is:

1. A drum brake comprising:
a motor configured to generate rotational driving force;
a pair of press units configured to press a pair of brake shoes toward an inner peripheral surface of a drum; and
a power transmission unit configured to transmit the rotational driving force of the motor to the pair of press units,
wherein the power transmission unit includes:
a rotatable member configured to be rotatable by the rotational driving force of the motor, and
a rotatable screw operably coupled to the rotatable member, and configured to be movable toward or away from the inner peripheral surface of the drum, and
at least one of the press units includes:
a press member disposed around one end of the rotatable screw and configured to press one of the pair of the brake shoes toward the inner peripheral surface of the drum by axial force of the rotatable screw, and
a force sensor disposed between the rotatable screw and the press member, and configured to sense force pressing the press member.

2. The drum brake of claim 1, wherein the press member and the force sensor are configured to be slidably movable in a movable direction of the rotatable screw.

3. The drum brake of claim 1, wherein the force sensor is disposed in an inner accommodation space of the press member.

4. The drum brake of claim 3, wherein the inner accommodation space of the press member has a gap for the force sensor to be slidably movable within the inner accommodation space of the press member.

5. The drum brake of claim 1, wherein the press member includes:
a floor portion in which one side of the press member is in contact with the force sensor; and
a wing portion extending in a longitudinal direction of the rotatable screw from a circumference of the floor portion such that another side of the press member is opened.

6. The drum brake of claim 1, wherein the force sensor includes a protrusion portion protruding toward the press member.

7. The drum brake of claim 6, further including an electrical line connected to a side surface of the force sensor.

8. The drum brake of claim 7, wherein at least a part of the electrical line connected to the force sensor is disposed in a hole formed at a side surface of the press member.

9. The drum brake of claim 8, wherein:
the hole of the press member is formed at a bottom of the press member, and
the electrical line connected to the force sensor is disposed below the force sensor.

10. The drum brake of claim 9, wherein the hole of the press member has a space in which the electrical line connected to the force sensor is slidably movable together with the force sensor.

11. The drum brake of claim 10, wherein one side of the hole of the rotatable screw is opened.

12. The drum brake of claim 1, wherein the power transmission unit includes:
a first gear coupled to a rotatable shaft of the motor,
a second gear rotatably engaged with the first gear,
a third gear formed or mounted on an outer peripheral surface of the rotatable member, and
a transmission shaft rotatably connected between the second gear and the third gear to transmit a rotational force of the second gear to the third gear.

13. The drum brake of claim 12, wherein:
the third gear is a worm gear, and
the transmission shaft has a worm rotatably engaged with the third gear on an outer peripheral surface of the transmission shaft.

14. The drum brake of claim 1, wherein the rotatable member has a ball nut operably coupled to the rotatable screw.

15. The drum brake of claim 12, further comprising a guide housing in which the power transmission unit is disposed,
wherein the power transmission unit further includes a pair of bushes between which the third gear is positioned, and the bushes have a ring shape to support an inner peripheral surface of the guide housing.

16. The drum brake of claim 15, wherein the power transmission unit further includes a stopper disposed between the press member and one of the pair of bushes positioned at the press member.

17. The drum brake of claim 16, wherein:
the guide housing further includes a stopper groove formed in a radial direction on the inner peripheral surface of the guide housing, and
the stopper of the power transmission unit has a C shape and is positioned on the stopper groove of the guide housing.

18. The drum brake of claim 1, wherein the power transmission unit further includes a thrust bearing disposed between the rotatable member and the press member.

19. The drum brake of claim 18, further comprising:
a third bush disposed between the rotatable member and the thrust bearing of the power transmission unit.

20. A drum brake comprising:
a motor configured to generate rotational driving force;
a pair of press units configured to press a pair of brake shoes toward an inner peripheral surface of a drum;
a power transmission unit configured to transmit the rotational driving force of the motor to the pair of press units;
a force sensor disposed inside at least one of the pair of press units and configured to sense force pressing a press member included in one of the pair of press units; and
a controller configured to control the motor based on information received from the force sensor through an electrical line electrically connected to the force sensor.
